(19) United States
(12) Patent Application Publication
(10) Pub. No.: US 2012/0037123 A1
(43) Pub. Date: Feb. 16, 2012

(54) FUEL SUPPLY SYSTEM

(75) Inventors: Franz Groth, Berlin (DE); Markus Rudolf, Graz (AT); Walter Schimpl, Graz (AT)

(73) Assignee: MAGNA STEYR FAHRZEUGTECHNIK AG & CO KG, Graz (AT)

(21) Appl. No.: 13/198,567

(22) Filed: Aug. 4, 2011

(30) Foreign Application Priority Data
Aug. 10, 2010 (DE) 10 2010 033 898.2

(51) Int. Cl. F02M 61/14

(52) U.S. Cl. 123/470

(57) ABSTRACT

A fuel supply system for an internal combustion engine has an air filter for cleaning intake air comprising a housing and a filter element, an intake unit for supplying the cleaned intake air to combustion chambers of the internal combustion engine and a fuel injection unit comprising a container for pressurized fuel, in particular a fuel distribution rail, and a plurality of injectors connected with the container. The fuel injection unit is integrated in the air filter.

### BACKGROUND OF THE INVENTION

The present invention relates to a fuel supply system for an internal combustion engine having an air filter for cleaning intake air comprising a housing and a filter element, an intake unit for supplying the cleaned intake air to combustion chambers of the internal combustion engine and a fuel injection unit comprising a container for pressurized fuel, in particular a fuel distribution rail, and a plurality of injectors connected with the container.

An ignitable air/fuel mixture is produced by injecting the fuel into the intake air, wherein the ignitable air/fuel mixture is ultimately combusted in the combustion chambers of the engine. Usually each engine cylinder, i.e. each combustion chamber of the internal combustion engine, has an injector of its own. The container, which is shared by all the cylinders, serves as buffer storage for the fuel to be injected, wherein the fuel to be injected is pressurized by a fuel pump which is likewise shared by all the cylinders. Such a container is also referred to as a fuel distribution rail or “rail”. The fuel distribution rail acts as a pressure storage shared by all the injectors, which is why the injection pressure is independent of the pump cycle.

In recent years, especially in the motor vehicle industry, increasingly strict emission regulations and soaring crude oil prices have brought the use of alternative fuels more and more into the focus of engine developers. Examples of alternative vehicle fuels are liquefied petroleum gas (LPG) and compressed natural gas (CNG), which are successfully employed especially in commercial vehicles as well as in passenger transportation. Such alternative-fuel engines reach the performance of conventional diesel engines and beat them in terms of pollutant emission, noise generation and consumption values.

Of special interest are vehicle engines having a bivalent drive, i.e. engines which can be operated alternately with a primary fuel, such as gasoline or diesel, and with an alternative fuel, such as liquid gas. Since standard gasoline engines can in principle also be operated with liquid gas, corresponding retrofitting systems have been developed. These are based on the fact that an additional injection unit for the alternative fuel is installed at the engine. With regard to the previously mentioned “rail” concept this means that an additional fuel distribution rail is to be provided in the proximity of the fuel inlets of the internal combustion engine. Herein, it is, however, problematic that, due to limited constructional space in modern vehicle engines, there is often not enough space for mounting an additional fuel distribution rail at the intake unit. In particular, the air filter, which in many standard engines is mounted directly above the intake unit, obstructs the space for installing a second intake unit. In principle, the additional fuel distribution rail could be provided at a greater distance from the fuel inlets. However, a provision of longer pressure lines leading from such a fuel distribution rail arranged at a greater distance to the injectors is undesirable for cost reasons. In addition, if the fuel injection rail exceeds a certain length, it will not sufficiently fulfill its function as a compensation tank any more. Pressure lines of such high length would, however, be actually required in many existing engine systems because there is no sufficient space available in the immediate environment of the fuel inlets. Arranging the fuel distribution rail above the air filter box is unfavorable for the reason alone that often engine casing parts are arranged in this area. Further, for safety reasons, there must always be observed a predetermined distance between the individual engine parts and the engine hood in order to ensure that there is a sufficient deformation path, for example, in the event that a pedestrian collides with the engine hood. Consequently, standard retrofitting systems cannot be used for engines having the mentioned constructional space limitations.

It is the object of the invention to indicate a way of overcoming this dilemma.

### SUMMARY OF THE INVENTION

This object is achieved by a fuel supply system according to the invention, the fuel injection unit is integrated in the air filter. This can be done in a simple manner because there is generally enough space in the housing of the air filter for accommodating a fuel distribution rail and the related injectors. By integrating the fuel injection unit and the air filter, supply of an alternative fuel is enabled without enlarging the constructional space and without the disadvantages of long lines between the fuel distribution rail and the injectors. Thus an existing internal combustion engine can be retrofitted for bivalent operation in a simple manner such that two different fuels can be utilized. This extends the cruising range of the respective vehicle and increases its driving efficiency.

Preferably, the fuel injection unit is arranged inside the air filter housing. Thus the space available inside the air filter housing is utilized for accommodating a fuel injection unit for the internal combustion engine. In this way, an additional injection unit for alternative fuel can be provided in cases where there is already a primary injection unit installed without enlarging the constructional space.

According to an embodiment of the invention, the air filter housing is configured in several parts, in particular in two parts, and the fuel injection unit is integrated in one of the parts. This enables simple and cost-efficient manufacturing. In particular, only one part of the air filter housing has to be adapted, whereas the second part or the remaining parts can be used in standard configuration, which is especially advantageous in view of series production.

Preferably, the fuel injection unit is integrated in a lower part of the air filter housing. When retrofitting the internal combustion engine, thus only the lower part is to be replaced by a correspondingly adapted lower part with integrated injection unit.

According to an embodiment of the invention, seats for mounting the fuel injection unit are provided in the air filter housing. The seats may in particular be seats for a screw connection, an adhesive connection or a rivet connection. This facilitates installation of the injection unit in the air filter.

In particular, the seats may be configured for mounting the container and/or for mounting the injectors. Depending on the respective application, thus the fuel distribution rail or the injectors, or the fuel distribution rail as well as the injectors, may be attached to the air filter housing. Alternatively or additionally the injectors may also be passed through the air filter housing and be attached to the intake unit.

According to another embodiment, the air filter housing and the fuel injection unit are configured as an integral component, in particular as a cast part or an injection molded part. In the case of this embodiment, it is not necessary to install a separate injection unit in the air filter housing, enabling especially simple and cost-efficient manufacturing.

As mentioned above, a further fuel injection unit may be provided which is not integrated in the air filter. This fuel injection unit may be the primary fuel injection unit or main injection unit, which is, for example, configured for supplying gasoline and is present in engines with monovalent drive as well as in engines with bivalent drive. This injection unit is not integrated in the air filter in order to avoid unnecessary assembly work in the case of internal combustion engine variants having a monovalent drive.

Preferably, the two fuel injection units are configured for injecting different fuel types. In particular, one of the fuel injection units may be configured for injecting a liquid fuel, especially gasoline, and the other fuel injection unit may be configured for injecting a gas fuel, especially liquid gas or natural gas. In this case, the internal combustion engine may alternately be operated with liquid fuel or with gas fuel, wherein the advantages of the respective fuel type can be utilized depending on the driving situation.

### BRIEF DESCRIPTION OF THE DRAWINGS

Hereinafter the invention will be described with reference to the accompanying drawings, wherein

FIG. 1 shows a perspective view of an intake unit of an internal combustion engine, wherein an air filter for cleaning intake air is mounted on the intake unit;

FIG. 2 shows a simplified sectional view of the arrangement according to FIG. 1;

FIG. 3 shows a sectional view of a fuel supply system according to a first embodiment of the invention;

FIG. 4 shows a sectional view of a fuel supply system according to a second embodiment of the invention;

FIG. 5 shows a sectional view of a fuel supply system according to a third embodiment of the invention.

### DETAILED DESCRIPTION

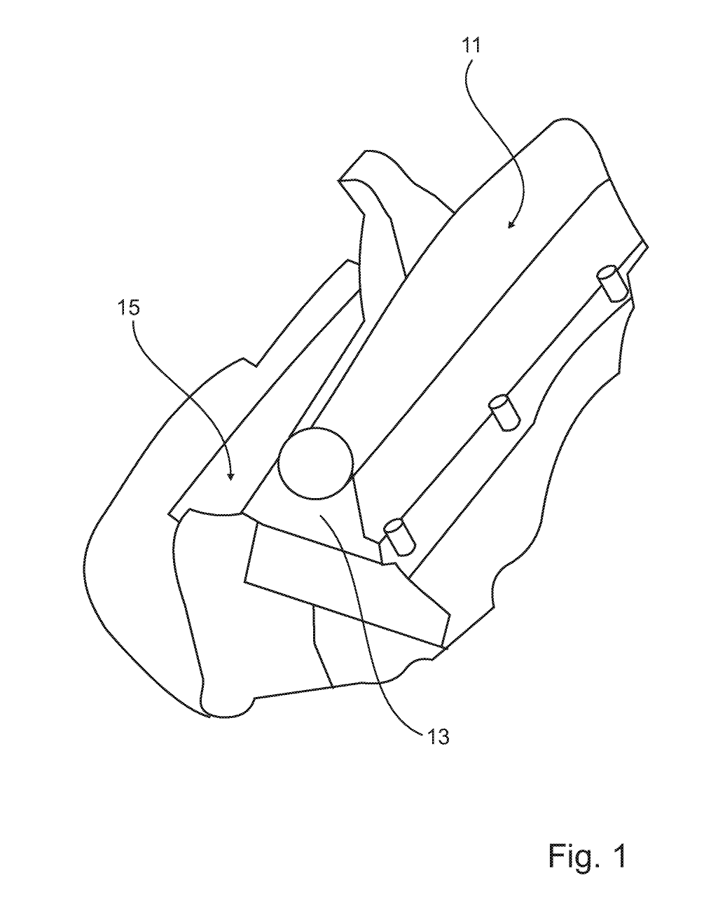

FIG. 1 shows part of a fuel supply system, which provides an ignitable mixture of intake air and fuel to an internal combustion engine not shown. An air filter module or air filter box 11 having a housing 13 and a filter element not shown, which is arranged in the housing 13 for cleaning intake air, is mounted on an intake unit 15 by means of mounts not shown, wherein the intake unit 15 supplies the intake air cleaned by the filter element to cylinders of the internal combustion engine.

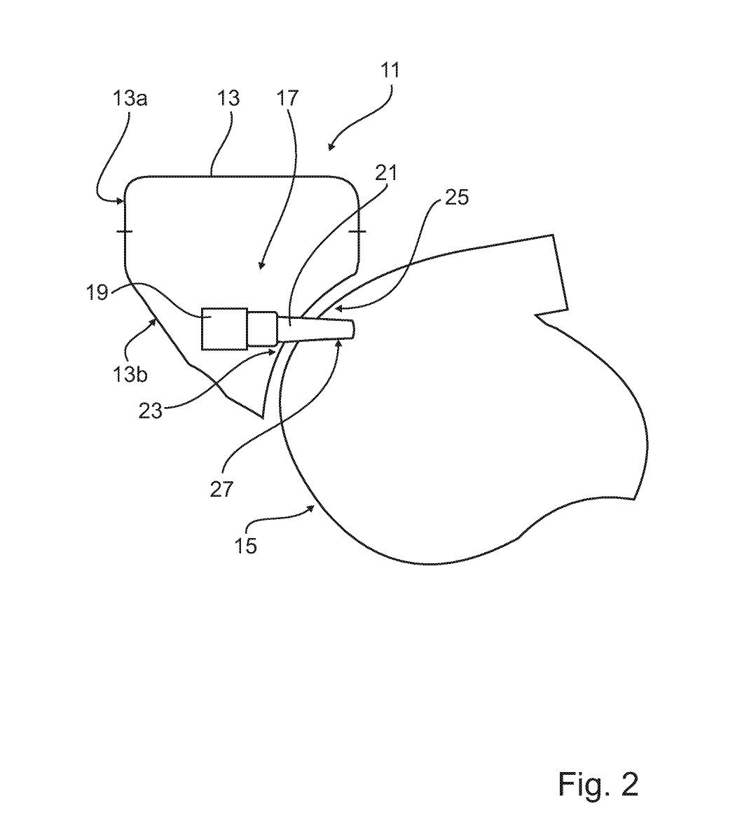

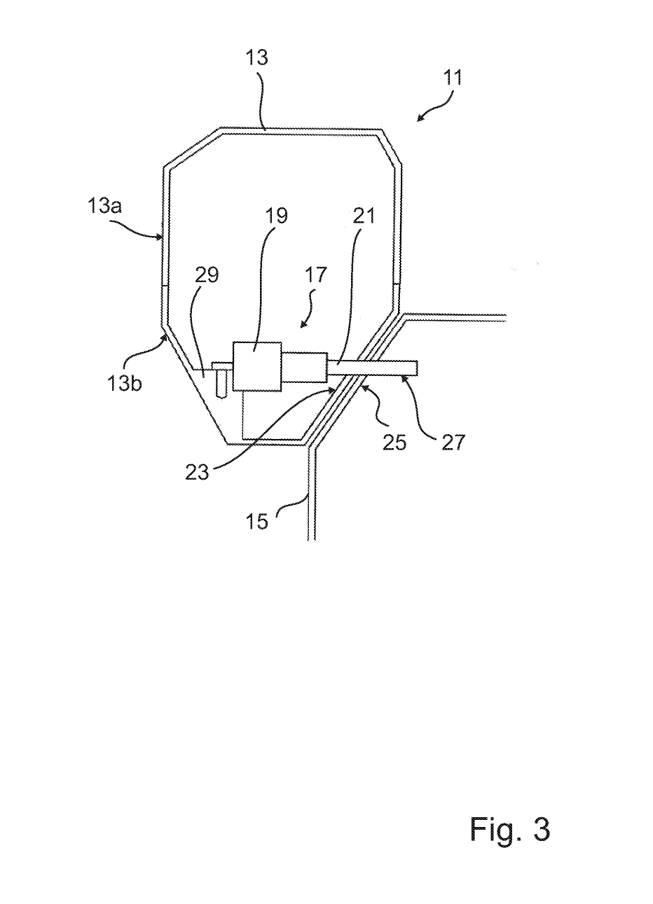

As can be seen in FIG. 2, the air filter housing 13 is divided into a top part 13a and a bottom part 13b, wherein a fuel injection unit 17 is integrated in the bottom part 13b. The fuel injection unit 17 serves to inject fuel into the intake unit 15, in order to produce an ignitable air/fuel mixture. The fuel injection unit 17 comprises a fuel distribution rail 19 as well as a plurality of injectors 21 connected with the fuel distribution rail 19, wherein the injectors 21 are passed through a wall portion 23 of the air filter housing 13 as well as through an adjacent wall portion 25 of the intake unit 15 and open into the interior of the intake unit 15. Except for the front portion 27 of the injectors 21 projecting into the intake unit 15, the fuel injection unit 17 is arranged completely inside the air filter housing 13. The fuel injection unit 17 may be attached in different ways in the air filter module 11, as explained hereinafter with reference to FIGS. 3 to 5.

According to FIG. 3, screw seats 29 are provided in the bottom part 13b of the air filter housing 13, wherein the fuel distribution rail 19 is screwed to the housing wall by means of the screw seats 29.

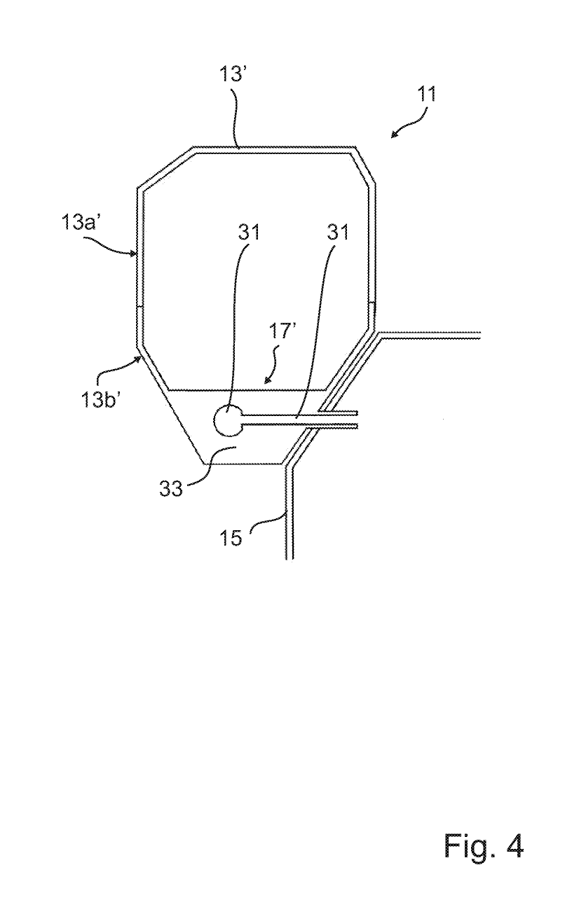

In the embodiment according to FIG. 4, no separate fuel injection unit is attached to the air filter housing 13′, but the bottom part 13b′ of the air filter housing 13′ and the fuel injection unit 17′ are configured as a single combined component. The fuel distribution rail and the injectors may in particular be configured as channels 31 in a cast part 33.

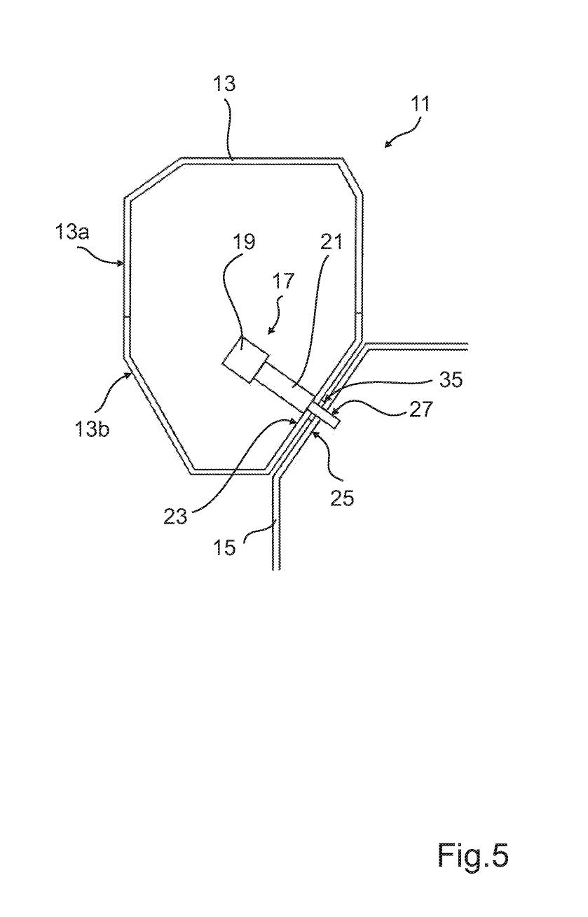

FIG. 5 shows an embodiment of the invention, wherein attachment of the fuel injection unit 17 is realized exclusively via the injectors 21, namely by means of a rubber clamp connection 35 at the intake unit 15. The fuel distribution rail 19 is carried by the attached injectors 21 such that no separate attachment seats are to be provided for it.

In principle, the previously described fuel supply system can be configured for a monovalent drive of the internal combustion engine with gasoline or with liquid gas. However, integration of the fuel injection unit in the air filter is especially advantageous in cases where two separate fuel injection units are used, one of which is configured for gasoline operation and the other one for liquid gas operation. That is to say that the principle according to the invention considerably increases flexibility in engine manufacture. In particular, the air filter housing comprising the possible adaptations, for example, suitable screw seats, may be manufactured and delivered in the usual manner. This air filter housing may, in principle, also be used for engines having a monovalent drive, wherein the fuel injection unit 17 is arranged outside the air filter and the screw seats are not utilized. Retrofitting the respective motor vehicle for bivalent operation can be done in a simple manner by subsequently installing a separate fuel injection unit in the air filter. Of course, it is also possible to manufacture engines which are from the beginning designed for bivalent operation. Herein it is especially advantageous that expensive redesigning of the engine is avoided, in which case from the beginning constructional space would have to be allowed for an additional fuel injection unit.

1-13. (canceled)

14. A fuel supply system for an internal combustion engine, comprising:
an air filter for cleaning intake air comprising a housing and a filter element;
an intake unit for supplying the cleaned intake air to combustion chambers of the internal combustion engine; and
a fuel injection unit comprising a container for pressurized fuel, in particular a fuel distribution rail, and a plurality of injectors connected with the container, wherein the fuel injection unit is integrated in the air filter.

15. The fuel supply system according to claim 14, wherein the fuel injection unit is arranged inside the air filter housing.

16. The fuel supply system according to claim 14, wherein the air filter housing is configured in two parts and the fuel injection unit is integrated in one of the parts.

17. The fuel supply system according to claim 16, wherein the fuel injection unit is integrated in a lower part of the air filter housing.

18. The fuel supply system according to claim 15, wherein seats for mounting the fuel injection unit are provided in the air filter housing.

19. The fuel supply system according to claim 18, wherein the seats are configured for mounting the container and/or for mounting the injectors.

20. The fuel supply system according to claim 19, wherein the container is attached to a wall of the air filter housing.

21. The fuel supply system according to claim 19, wherein the injectors are passed through the air filter housing and attached to the intake unit by a rubber clamp connection.

22. The fuel supply system according to claim 16, wherein the air filter housing and the fuel injection unit are configured as an integral component, in part.

23. The fuel supply system according to claim 22, wherein the container and/or the injectors are configured as channels in the part.

24. The fuel supply system according to claim 14, wherein a further fuel injection unit is provided which is not integrated in the air filter.

25. The fuel supply system according to claim 24, wherein the two fuel injection units are configured for injecting different fuel types.

26. The fuel supply system according to claim 25, wherein one of the fuel injection units is configured for injecting a liquid fuel, and the other fuel injection unit is configured for injecting a gas fuel.
